(19) United States
(12) Patent Application Publication
(10) Pub. No.: US 2010/0328556 A1
(43) Pub. Date: Dec. 30, 2010

(54) ILLUMINATION DEVICE, DISPLAY DEVICE, AND TELEVISION RECEIVER APPARATUS

(75) Inventor: Kaori Yamamoto, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/867,531

(22) PCT Filed: Jan. 26, 2009
(86) PCT No.: PCT/JP2009/051215

§ 371 Date: Aug. 13, 2010

(30) Foreign Application Priority Data
Feb. 27, 2008 (JP) 2008-046727

(51) Int. Cl. H04N 3/14; F21V 21/00; G02F 1/13357

(52) U.S. Cl. 348/790; 362/382; 349/61; 348/E03.016

(57) ABSTRACT

An illumination device 12 according to the present invention includes a light source 17, a chassis 14 that houses the light source 17, and a stand 40 that holds the chassis 14 in an upright position. The stand 40 includes support portions 44 and 45 that directly support the chassis 14. Vertical rails 51 and 52 are mounted on a surface of the chassis 14 on an opposite side from the light source 17 with longitudinal directions thereof aligned with a vertical direction of the chassis 14 and connected to the support portions 44 and 45. Diagonal rails 61 and 62 are mounted on the surface of the chassis 14 with longitudinal directions thereof aligned with directions that intersect with the vertical direction of the chassis and connected to the support portions 44 and 45 to which the vertical rails 51 and 52 are connected.

### TECHNICAL FIELD

The present invention relates to an illumination device, a display device, and a television receiver apparatus.

### BACKGROUND ART

Recently, display elements of image display devices such as a television receiver apparatus are undergoing a rapid transition from conventional cathode-ray tubes to thin display devices using thin display elements such as liquid crystal panels and plasma display panels. Such thin display devices enable thinning and weight saving of image display devices.

With a liquid crystal display device using a liquid crystal panel, since the liquid crystal panel is not self-luminous, the liquid crystal display device separately requires a backlight unit as an illumination device. Such a backlight unit is intended to be installed on a rear side (the side opposite to a display screen) of the liquid crystal panel and, for example, includes: a metallic chassis having an opened face on the liquid crystal panel-side; and a large number of light sources (for example, cold cathode tubes) housed in the chassis.

The aforementioned light source creates a leak, albeit only slightly, to the metallic chassis when lighting. The amount of leakage is inversely proportional to a distance between the light source and the chassis. Therefore, when warpage of the chassis occurs due to insufficient strength, a variance in the distances between the respective light sources and the chassis occurs, creating a difference in output light intensity per light source and a risk of a display quality loss of the liquid crystal display device. In particular, when a light source and the chassis approach each other up to or under a predetermined distance, an increase in leakage may cause lighting failure of the light source. Accordingly, a high bending strength is required for the chassis. A structure disclosed in Patent Document 1 is known as means for realizing such a high bending strength of the chassis.

The chassis structure disclosed in Patent Document 1 is formed by fixing a peripheral edge part of a bottom plate with a picture frame-like frame divided into a plurality of portions. The plurality of divided portions is connected by mortise-tendon joints. In this manner, the chassis structure is configured so as to improve the bending strength of the chassis by fixing the peripheral edge part of the bottom plate with the frame.

Patent Document 1: Japanese Patent Laid-Open No. 2006-201318

### PROBLEMS TO BE SOLVED BY THE INVENTION

Meanwhile, since a liquid crystal display device is generally used in an upright state, a stand that supports the liquid crystal display device along a vertical direction is connected to a chassis that makes up a backlight unit. Therefore, a distortion force generated by the chassis' own weight and vibration of the chassis occurs around a portion of the chassis at which the stand is connected. However, since only the peripheral edge part of the chassis is reinforced in the chassis structure disclosed in Patent Document 1, there are cases where the chassis structure cannot respond sufficiently to a distortion force that is applied to the portion where the stand is connected.

### DISCLOSURE OF THE INVENTION

The present invention has been made in consideration of circumstances such as described above, and an object thereof is to provide an illumination device with superior uniformity of illumination luminance distribution by suppressing chassis distortion with a simple configuration and maintaining a constant distance between a light source and the chassis. Another object of the present invention is to provide a display device including such an illumination device, as well as a television receiver apparatus including such a display device.

### MEANS FOR SOLVING THE PROBLEMS

In order to solve the problems described above, an illumination device according to the present invention includes a light source, a chassis that houses the light source and a stand that holds the chassis in an upright position. The stand includes a support portion that directly supports the chassis. A vertical rail is mounted on a surface of the chassis on an opposite side from the light source with a longitudinal direction thereof aligned with a vertical direction of the chassis and connected to the support portion. A diagonal rail is mounted on the surface of the chassis with a longitudinal direction thereof aligned with a direction that intersects with the vertical direction of the chassis and connected to the support portion to which the vertical rail is connected.

According to such a configuration, since a chassis is reinforced by the vertical rail and the diagonal rail mounted to the chassis and the vertical rail and the diagonal rail are connected to a support portion, distortion force that is likely to concentrate on a connection between the chassis and the support portion can be dispersed. As a result, chassis distortion can be suppressed.

With a chassis supported by a stand in an upright position, distortion force tends to concentrate on a connection between the chassis and the stand due to the chassis' own weight, vibration of the chassis, and the like. When chassis distortion occurs, for example, in a case where a plurality of light sources is arranged, a variance is created among distances between the respective light sources and the chassis. If a metallic chassis is used, a slight leak is created from the light source to the chassis. The amount of leakage is inversely proportional to the distance between the light source and the chassis. Therefore, a variance among the distances between the respective light sources and the chassis results in different output light intensities among the respective light sources and may cause luminance unevenness in the illumination device. In particular, when a light source and the chassis approach each other up to or under a predetermined distance, an increase in leakage may cause lighting failure of the light source. In addition, in order to realize a thinner illumination device, it is desirable to minimize the distance between a light source and a chassis. In this case, a slight change in the distance between the light source and the chassis relatively causes a significant variance in leakage.

In order to maintain a constant distance between the light source and the chassis, according to a configuration of the present invention, a vertical rail and an diagonal rail are provided together on a surface of the chassis on an opposite side from the light source, in other words, a side opposite from the output side of illumination light. The vertical rail is mounted on the chassis with a longitudinal direction thereof aligned with a vertical direction of the chassis and connected to the support portion that directly supports the chassis. In this case, the vertical direction refers to a top-to-bottom direction of the illumination device in the upright position. Since the chassis is reinforced with respect to the vertical direction, distortion due to the illumination device's own weight can be suppressed. In addition, distortion force that tends to concentrate on the connection between the chassis and the support portion can be dispersed in the vertical direction through the vertical rail and thus distortion force is less likely to be applied to a small area. Therefore, chassis distortion can be suppressed.

According to the configuration of the present invention, an diagonal rail is mounted on the chassis with a longitudinal direction thereof aligned with a direction that intersects the vertical direction of the chassis and connected to the support portion. As a result, the chassis can also be reinforced in an alignment direction of the diagonal rail and distortion force that tends to concentrate on the connection between the chassis and the support portion can be dispersed not only in the vertical direction but also in the direction that intersects the vertical direction. Since distortion force is to be dispersed over a wide area of the chassis, chassis distortion can be reliably suppressed.

As described above, the vertical rail aligned with the vertical direction of the chassis and the diagonal rail aligned with the direction that intersects the vertical direction are mounted on the rear surface of the chassis and connected to the support portion of the stand. Therefore, the chassis is reinforced across a wide area of the chassis and distortion force applied to the chassis can be dispersed. As a result, chassis distortion is suppressed and the distance between the light source and the chassis is kept constant. A uniform luminance of the illumination without luminance unevenness can be provided.

### BRIEF DESCRIPTION OF THE DRAWINGS

FIG. 1 is a front view illustrating a mode of installation of a television receiver apparatus according to an embodiment of the present invention;

FIG. 2 is an exploded perspective view illustrating a schematic configuration of the television receiver apparatus;

FIG. 3 is an exploded perspective view illustrating a schematic configuration of a liquid crystal display device included in the television receiver apparatus;

FIG. 4 is a cross-sectional view illustrating a cross-sectional configuration of the liquid crystal display device in a short-side direction thereof;

FIG. 5 is a cross-sectional view illustrating a cross-sectional configuration of the liquid crystal display device in a long-side direction thereof;

FIG. 6 is a rear view illustrating a configuration of a rear face-side of a backlight unit;

FIG. 7 is a rear view illustrating a configuration of a stand included in the backlight unit;

FIG. 8 is a perspective view illustrating a configuration of a vertical rail included in the backlight unit;

FIG. 9 is a perspective view illustrating a configuration of a connection between the vertical rail and a diagonal rail included in the backlight unit;

FIG. 10 is a plan view illustrating a configuration of a connection between a chassis and a stand;

FIG. 11 is a cross-sectional view illustrating a configuration of a cross section taken along A-A in FIG. 10; and

FIG. 12 is a plan view illustrating a modification of a mode of arrangement of the vertical rail and the diagonal rail.

### BEST MODE FOR CARRYING OUT THE INVENTION

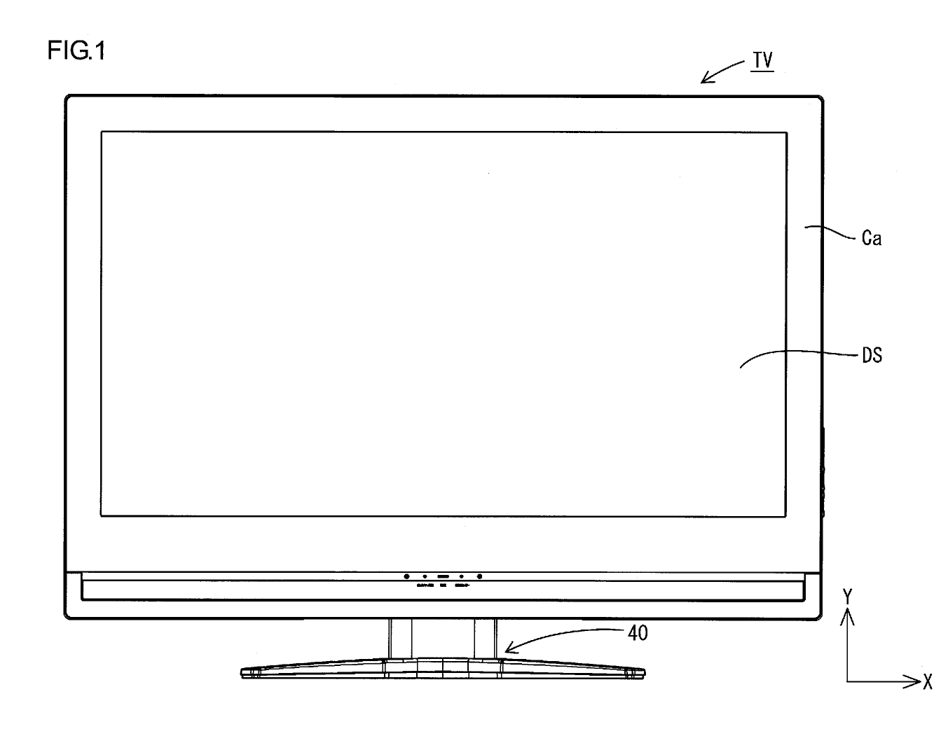

An embodiment of the present invention will now be described with reference to FIGS. 1 to 11. Note that in the drawings, an X-axis direction indicates a horizontal direction and a Y-axis direction indicates a vertical direction.

First, a configuration of a television receiver apparatus TV including a liquid crystal display device 10 will be described with reference to FIGS. 1 to 5.

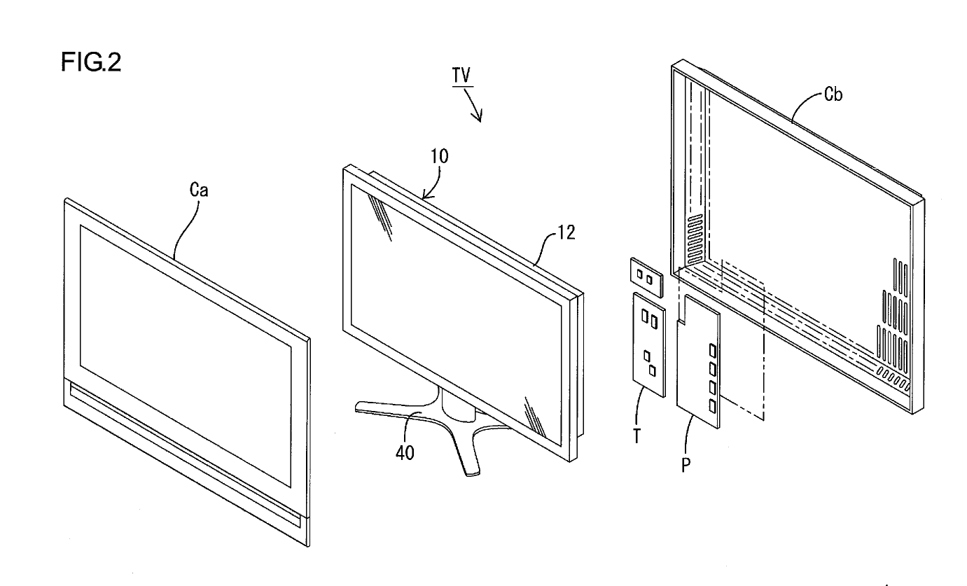

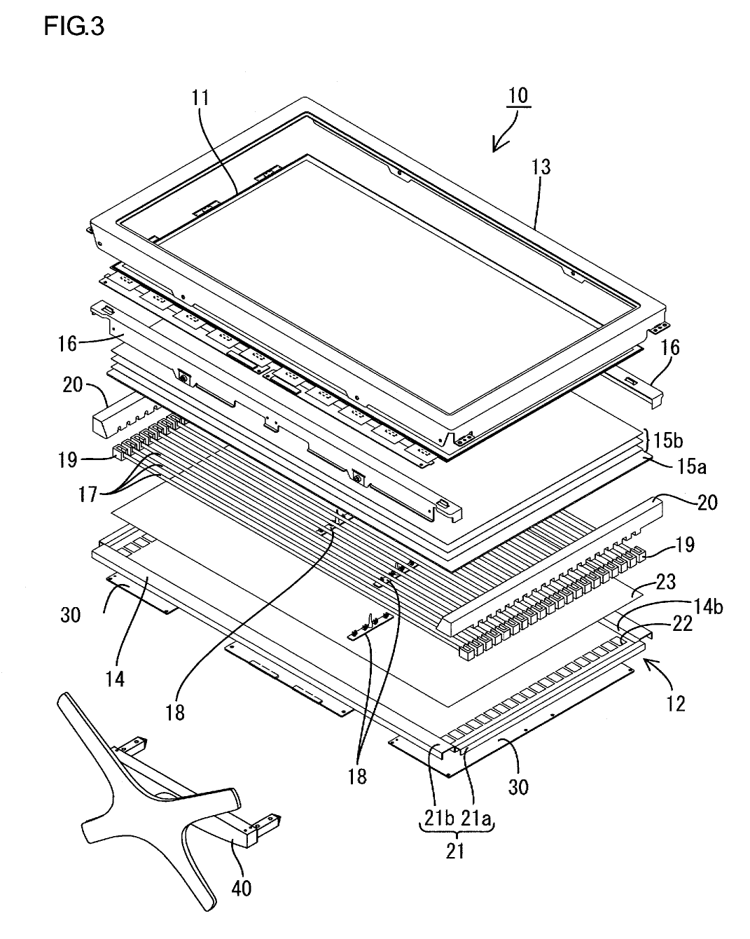

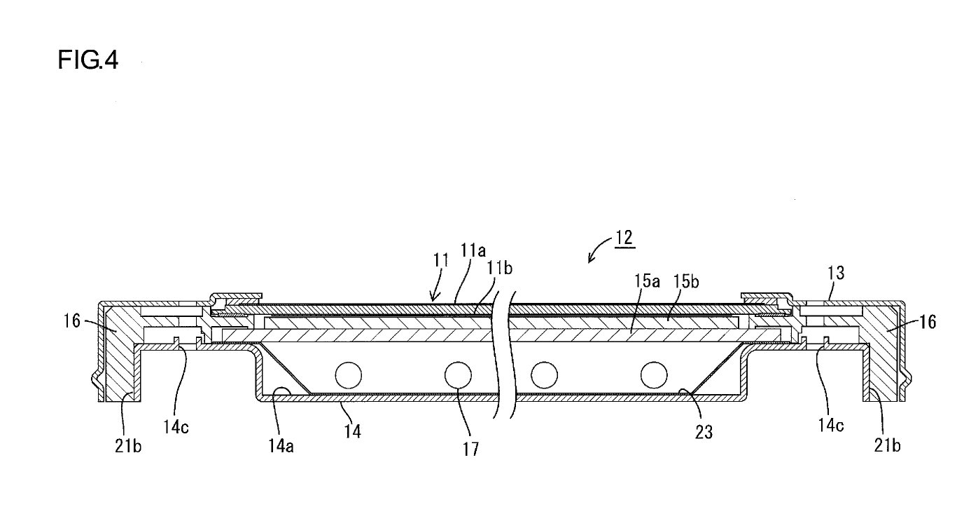

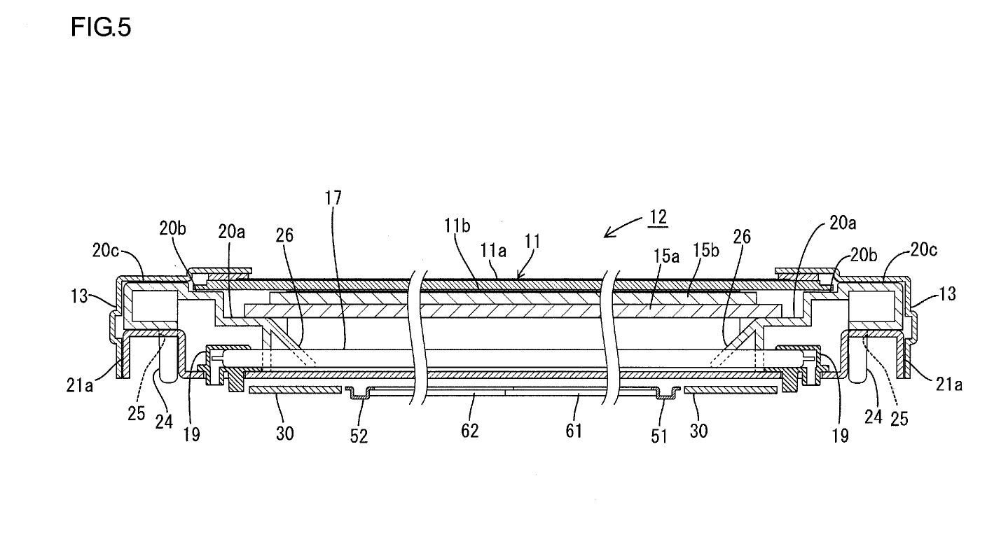

FIG. 1 is a front view illustrating a mode of installation of a television receiver apparatus according to the present embodiment. FIG. 2 is an exploded perspective view illustrating a schematic configuration of the television receiver apparatus illustrated in FIG. 1. FIG. 3 is an exploded perspective view illustrating a schematic configuration of a liquid crystal display device included in the television receiver apparatus illustrated in FIG. 1. FIG. 4 is a cross-sectional view illustrating a cross-sectional configuration of the liquid crystal display device illustrated in FIG. 3 along a short-side direction thereof. FIG. 5 is a cross-sectional view illustrating a cross-sectional configuration of the liquid crystal display device illustrated in FIG. 3 along a long-side direction thereof.

As illustrated in FIGS. 1 and 2, the television receiver apparatus TV according to the present embodiment includes: the liquid crystal display device 10; front and rear cabinets Ca and Cb which house the liquid crystal display device 10 so as to sandwich the same; a power source P; and a tuner T. The liquid crystal display device (display device) 10 as a whole forms a horizontally long rectangle and is housed in an upright state. As illustrated in FIG. 3, the liquid crystal display device 10 includes a liquid crystal panel 11 that is a display panel and a backlight unit (illumination device) 12 that is an external light source. The liquid crystal panel 11 and the backlight unit 12 are integrally held by a frame-like bezel 13 and the like. Moreover, as illustrated in FIG. 1, the television receiver apparatus TV is configured such that a television image display screen DS (a display screen of the liquid crystal panel 11) is supported to a predetermined height by a stand 40 included in the backlight unit 12. A viewer is able to view television images in a horizontal direction when the display screen DS is oriented in a vertical direction (the Y-axis direction in FIG. 1).

Next, the liquid crystal panel 11 and the backlight unit 12 comprising the liquid crystal display device 10 will be described (see FIGS. 3 to 5).

For the liquid crystal panel (display panel) 11, a pair of glass substrates is pasted together while being separated by a predetermined gap and liquid crystals are sealed between the two glass substrates. One of the glass substrates is provided with a switching element (for example, a TFT) connected to a source wiring and a gate wiring that intersect each other at right angles, a pixel electrode connected to the switching element, an alignment film, and the like. The other glass substrate is provided with a color filter on which respective colored portions such as R (red), G (green) and B (blue) are arranged in a predetermined alignment, a counter electrode, an alignment film, and the like. Moreover, polarizing plates 11a and 11b are arranged on the outsides of both substrates (see FIGS. 4 and 5).

As illustrated in FIG. 3, the backlight unit 12 includes: an approximately box-shaped chassis 14 opened to a light outputting face-side (a side of the liquid crystal panel 11); a diffusing plate 15a mounted so as to cover an opening 14b of the chassis 14; a plurality of optical sheets 15b arranged between the diffusing plate 15a and the liquid crystal panel 11; and a frame 16 which is arranged along a long side of the chassis 14 and which holds a long-side edge part of the diffusing plate 15a by sandwiching the same between the chassis 14. In addition, the stand 40 that supports the chassis 14 in an upright state along the vertical direction is provided at a central part of one of the long sides of the chassis 14. Furthermore, the chassis 14 is interiorly provided with: a cold cathode tube (light source) 17; a lamp clip 18 for mounting the cold cathode tube 17 to the chassis 14; relay connectors 19 responsible for relaying electrical connections at each end part of the cold cathode tube 17; and a holder 20 that covers all of the end parts of the cold cathode tube 17 and the group of relay connectors 19. Moreover, at the backlight unit 12, the diffusing plate 15a is closer to the light output side than the cold cathode tube 17.

The chassis 14 is made of aluminum and is sheet metal-processed and molded into a shallow, approximately box shape made up of: a rectangular bottom plate 14a; and a folded outer edge part 21 rising from the respective sides of the bottom plate 14a and folded in an approximate U-shape (a folded outer edge part 21a in a short-side direction and a folded outer edge part 21b in a long-side direction). Moreover, while an aluminum chassis 14 has been adopted in the present embodiment with an aim of reducing the weight of the chassis 14, for example, a metallic chassis 14 made of an iron-based material or the like may be adopted instead when a higher bending strength is required.

A plurality of mounting holes 22 for mounting the relay connectors 19 is drilled on both longitudinal end parts of the bottom plate 14a of the chassis 14. In addition, as illustrated in FIG. 4, a fixing hole 14c is drilled into an upper face of the folded outer edge part 21b of the chassis 14. For example, the fixing hole 14c enables the bezel 13, the frame 16, the chassis 14 and the like to be integrated by a screw or the like.

A reflection sheet 23 is arranged on an inner face-side (a side of the face opposing the cold cathode tube 17) of the bottom plate 14a of the chassis 14. The reflection sheet 23 is made of synthetic resin, has a surface colored white that is a color with superior light reflectivity, and is laid along an inner face of the bottom plate 14a of the chassis 14 so as to approximately cover the entire area of the bottom plate 14a. As illustrated in FIG. 4, a long-side edge part of the reflection sheet 23 rises so as to cover the folded outer edge part 21b of the chassis 14 and is sandwiched between the chassis 14 and the diffusing plate 15a. The reflection sheet 23 enables light emitted from the cold cathode tube 17 to be reflected to the side of the diffusing plate 15a. Meanwhile, inverter boards 30 are arranged on an outer surface (on a side opposite from the cold cathode tube 17) of the bottom plate 14a of the chassis 14 and supply power to the cold cathode tube 17.

In addition, the diffusing plate 15a and the optical sheet 15b are arranged on the side of the opening 14b of the chassis 14. The diffusing plate 15a is a synthetic resin plate-like member dispersedly mixed with light-scattering particles and functions to diffuse linear light emitted from the cold cathode tube 17 that is a tubular light source. As described above, the short-side edge part of the diffusing plate 15a is mounted on a first face 20a of the holder 20 and is configured so as to be unaffected by vertical binding forces. On the other hand, as illustrated in FIG. 4, the long-side edge part of the diffusing plate 15a is sandwiched between and therefore fixed by the chassis 14 (reflection sheet 23) and the frame 16.

The optical sheet 15b arranged on the diffusing plate 15a is a laminated structure of a diffusing sheet, a lens sheet, and a reflective polarizing plate, in this order, from the side of the diffusing plate 15a. The optical sheet 15b functions to convert light emitted from the cold cathode tubes 17 and passed through the diffusing plate 15a into planar light. The liquid crystal panel 11 is placed on an upper face-side of the optical sheet 15b. The optical sheet is held between the diffusing plate 15a and the liquid crystal panel 11.

Each cold cathode tube 17 has an elongated tubular shape. A large number of the cold cathode tubes 17 are housed in the chassis 14 aligned parallel to each other in a state where a longitudinal direction (an axial direction) of the cold cathode tubes 17 is conformed to the long-side direction of the chassis 14 (see FIGS. 3 and 5). Each cold cathode tube 17 is gripped by the lamp clip 18 (not illustrated in FIG. 5) in a state where a slight gap is provided between the cold cathode tube 17 and the bottom plate 14a (reflection sheet 23) of the chassis 14. Each end part of the cold cathode tube 17 is fit into the relay connector 19. The holder 20 is mounted so as to cover the relay connectors 19.

Moreover, the present embodiment is configured such that: the cold cathode tube 17 used has a tube diameter of 4.0 mm; the distance between the cold cathode tube 17 and the bottom plate 14a of the chassis 14 is set to 0.8 mm; the distance between adjacent cold cathode tubes 17 is set to 16.4 mm; and the distance between the cold cathode tube 17 and the diffusing plate 15a is set to 2.7 mm. As shown, thinning is applied among the respective components in the backlight unit 12. In particular, the distance between the cold cathode tube 17 and the diffusing plate 15a and the distance between the cold cathode tube 17 and the bottom plate 14a of the chassis 14 have been reduced. Due to such thinning of the backlight unit 12, a thickness of the liquid crystal display device 10 (i.e., a thickness from a front face of the liquid crystal panel 11 to a rear face of the backlight unit 12) of 16 mm and a thickness of the television receiver apparatus TV (i.e., a thickness from a front face of the front-side cabinet Ca to a rear face of the rear-side cabinet Cb) of 34 mm are realized. As a result, a thin television receiver apparatus is realized.

The holder 20 covering end parts of the cold cathode tubes 17 is made of white synthetic resin and, as illustrated in FIG. 3, has an approximately elongated box shape extending in the short-side direction of the chassis 14. As illustrated in FIG. 5, the holder 20 has a stepped face configured such that the diffusing plate 15a and the liquid crystal panel 11 can be mounted on different levels of a front face-side of the stepped face. The holder 20 is arranged so as to partially overlap the folded outer edge part 21a in the short-side direction of the chassis 14 and, together with the folded outer edge part 21a, forms a side wall of the backlight unit 12. An insertion pin 24 protrudes from a face of the holder 20 opposing the folded outer edge part 21a of the chassis 14. The holder 20 is mounted onto the chassis 14 by inserting the insertion pin 24 into an insertion hole 25 formed on an upper face of the folded outer edge part 21a of the chassis 14.

The stepped face of the holder 20 is made up of three faces parallel to the bottom plate 14a of the chassis 14. A short-side edge part of the diffusing plate 15a is mounted on a lowermost first face 20a of the stepped face of the holder 20. In addition, an inclined cover 26 that inclines toward the bottom plate 14a of the chassis 14 extends from the first face 20a. A short-side edge part of the liquid crystal panel 11 is mounted on a second face 20b of the stepped face of the holder 20. A topmost third face 20c of the stepped face of the holder 20 is arranged at a position overlapping the folded outer edge part 21a of the chassis 14 and is in contact with the bezel 13.

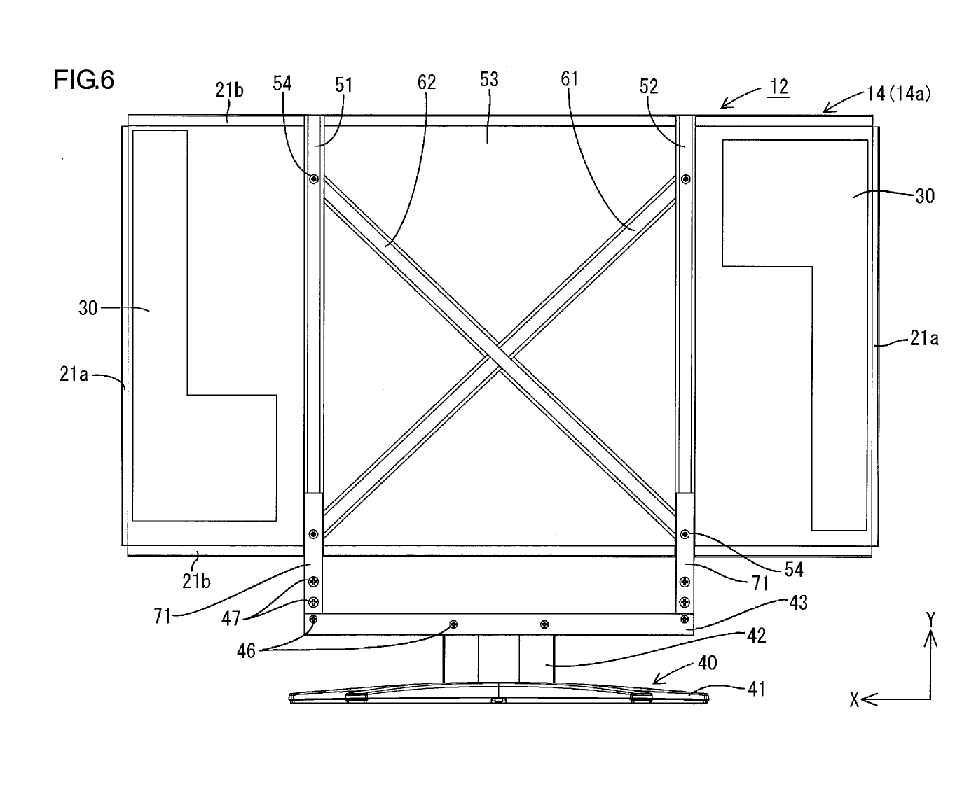

Next, a configuration of a rear face-side (a surface of the chassis 14 opposite from the side on which the cold cathode tubes 17 are arranged) of the backlight unit 12 will be described in detail with reference to FIGS. 6 to 11.

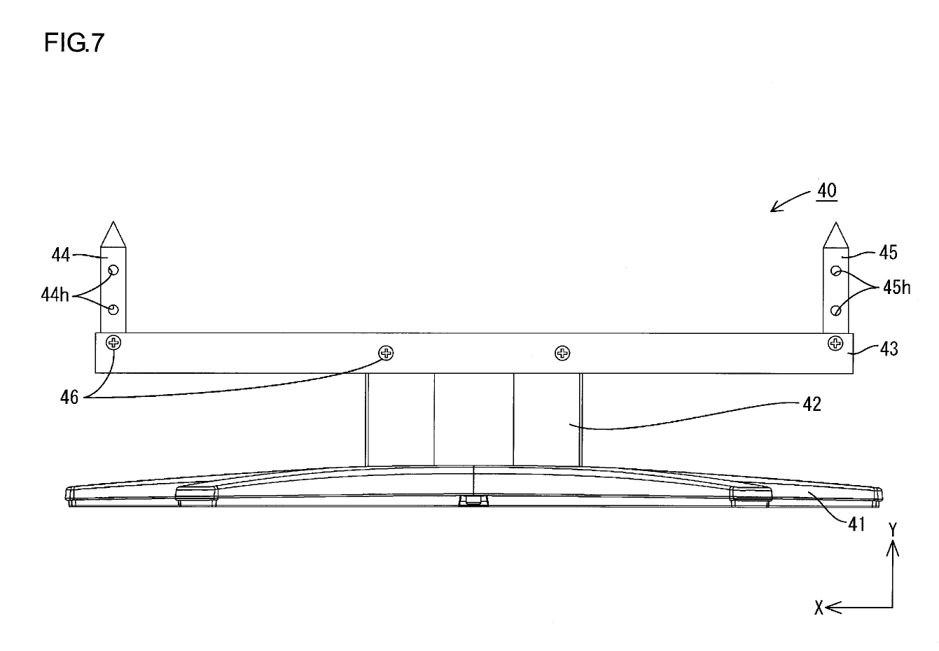

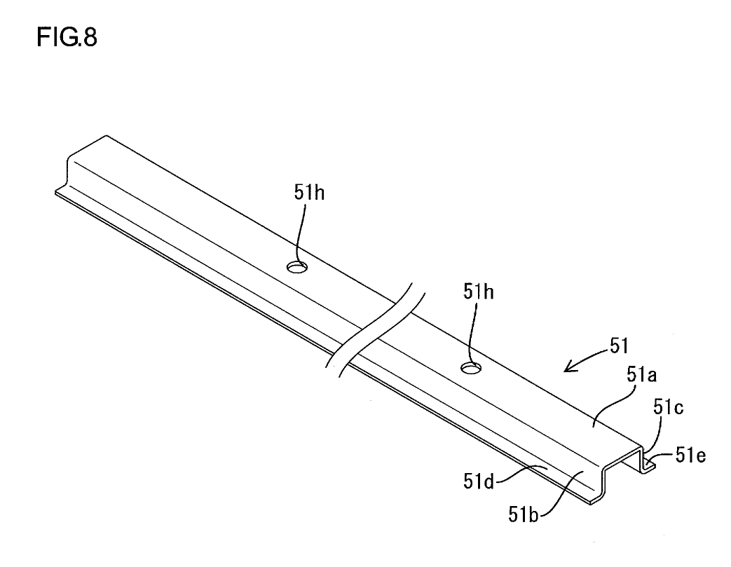

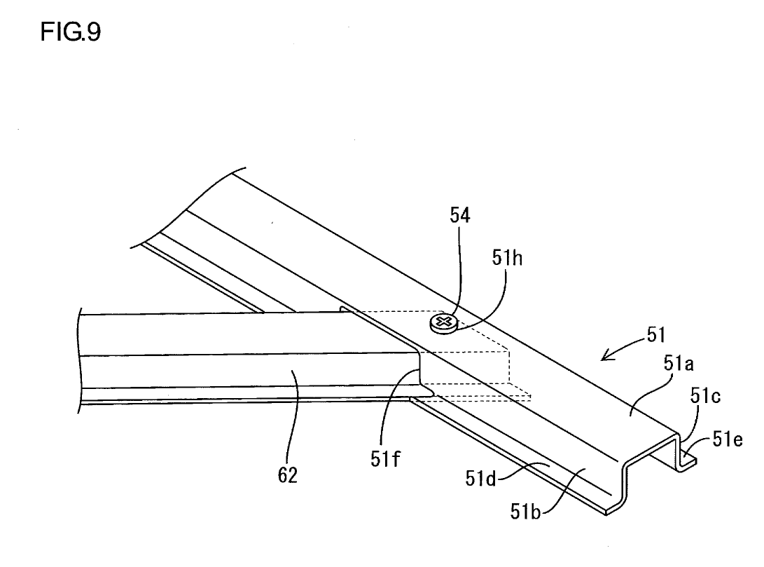

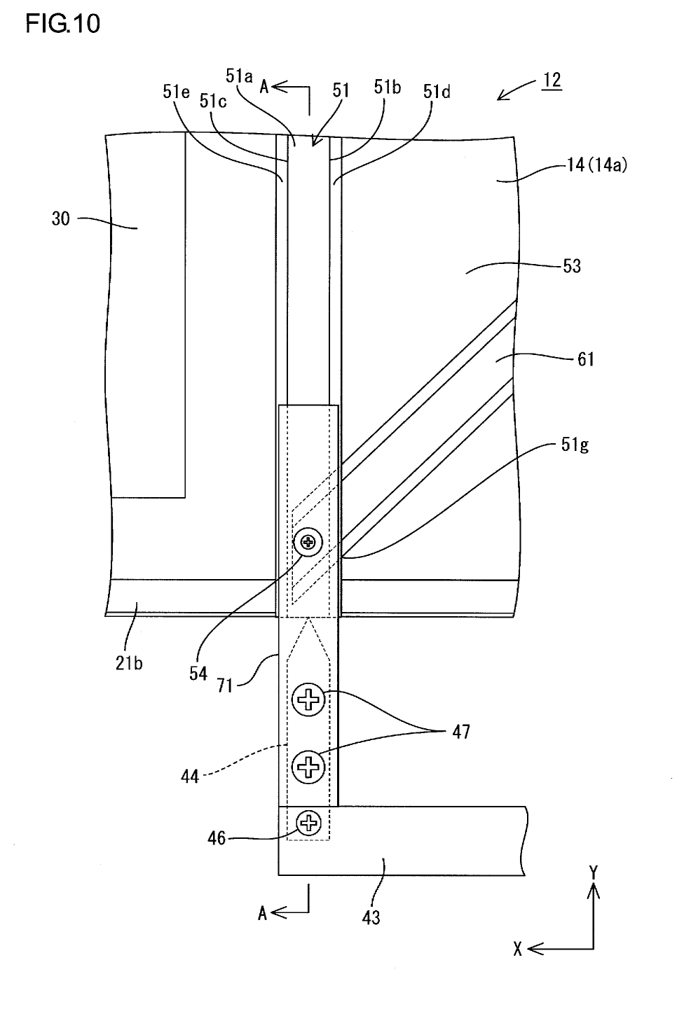

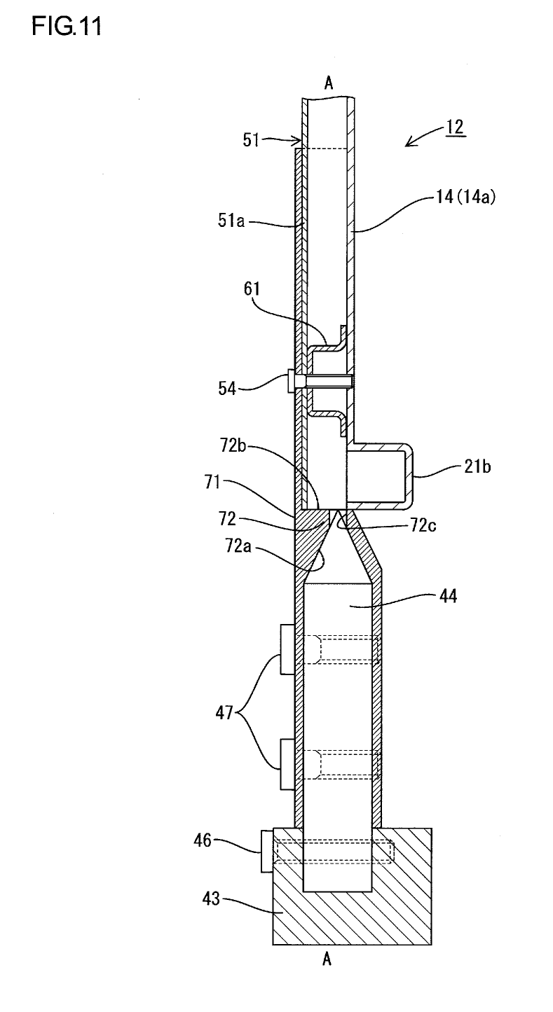

FIG. 6 is a rear view illustrating a configuration of a rear face-side of the backlight unit. FIG. 7 is a rear view illustrating a configuration of a stand included in the backlight unit illustrated in FIG. 6. FIG. 8 is a perspective view illustrating a configuration of a vertical rail included in the backlight unit illustrated in FIG. 6. FIG. 9 is a perspective view illustrating a configuration of a connection between a vertical rail and a diagonal rail. FIG. 10 is a plan view illustrating a configuration of a connection between the chassis and the stand. FIG. 11 is a cross-sectional view illustrating a configuration of a cross section taken along A-A in FIG. 10.

The backlight unit 12 held by the stand 40 in an upright position such that the planar surface of the bottom plate 14a of the chassis 14 is oriented in a vertical direction (the Y-axis direction in FIG. 6). In the present embodiment, the chassis 14 is held such that the short-side outer edge part 21a is aligned with the vertical direction (the Y-axis direction) and the long-side outer edge part 21b is aligned with the horizontal direction (the X-axis direction or the lateral direction in FIG. 6). In other words, the chassis 14 is held in a landscape orientation with the long-side outer edge parts 21b on the top and the bottom and with the short-side outer edge parts 21a at the right and the left. The stand 40 is mounted to the lower long-side outer edge part 21b.

As illustrated in FIG. 7, a base 41 that comes into contact with a surface (flat surface) on which the backlight unit 12 is placed is provided on a lowermost part of the stand 40. The stand 40 also includes a shaft 42, a support base portion 43, the first support portion 44 (support portion) and the second support portion 45 (support portion). The shaft 42 is mounted to the base 41 in the upright position so as to extend toward the chassis 14 (the upper side of FIG. 7). The support base portion 43 is mounted to the end (top end) of the shaft 42 so as to extend in the longitudinal direction (or horizontal direction) of the chassis 14. The first support portion (support portion) 44 and the second support portion (support portion) 45 are attached to the respective ends of the support base portion 43 in the upright position so as to extend toward the chassis 14 (toward the upper side of FIG. 7). In other words, axial directions of the shaft 42 and support portions 44 and 45 are aligned with the vertical direction (the Y-axis direction in the drawing). The components 41, 42, 43, 44 and 45 of the stand 40 have fitting structures, respectively and they are roughly fixed to each other by the structures. They are tightly fixed with screws 46.

The stand 40 is mounted to the chassis 14 such that the shaft 42 is positioned at a center of the long side of the chassis 14 and in an orientation with an axial direction of the support base portion 43 aligned with the long-side direction of the chassis 14 (see FIG. 6). In the present embodiment, the length of the support base portion 43 that measure in the axial direction is slightly shorter than a length of a portion of the chassis 14 at which the inverter boards 30 are not arranged. The length of the portion measures in the longitudinal direction of the chassis 14. In other words, the stand 40 is mounted closer to the center than the inverter boards 30 arranged at both end parts in the long-side direction of the chassis 14 and is in a positional relationship such that perpendiculars extended from both end parts of the support base portion 43 do not intersect with the inverter board 30.

Furthermore, as illustrated in FIG. 7, the first support portion 44 and the second support portion 45 are provided so as to extend from the upper surface (the surface opposing the chassis 14) of the support base portion 43 along the vertical direction (the Y-axis direction) towards the chassis 14, that is, they are in the upright positions. The support portions 44 and 45 are configured as square columns with approximately quadrate horizontal cross sections and are subjected to a drawing process so that tips (upper ends) of the support portions 44 and 45 form approximately triangular vertical cross sections. In other words, both support portions 44 and 45 are formed as approximate square columns with peaks oriented towards the side of the chassis 14. In addition, the support portions 44 and 45 have insertion holes 44h and 45h for screws 47.

Meanwhile, the first vertical rail (vertical rail) 51 is mounted on the bottom plate 14a of the chassis 14 at a position opposing the first support portion 44 of the stand 40, and the second vertical rail (vertical rail) 52 is mounted on the bottom plate 14a of the chassis 14 at a position opposing the second support portion 45. The first vertical rail 51 and the second vertical rail 52 are configured so as to have the same structure that will be described using the first vertical rail 51 as an example. The first vertical rail 51 is formed by subjecting a metal plate to a bending process and, as illustrated in FIG. 8, includes: a rectangular upper plate portion 51a; side plate portions 51b and 51c formed by roughly vertically bending both long-side end parts of the upper plate portion 51a; and lower plate portions 51d and 51e formed by roughly vertically bending both long-side end parts of the side plate portions 51b and 51c towards the outside. The space between the lower plate portion 51d and the lower plate portion 51e is left opened. Lower-side faces (faces opposing the chassis 14) of the lower plate portions 51d and 51e are configured as faces positioned at the same height (i.e., flush with each other). As described above, the first vertical rail 51 have a hollow structure in which a hollow is defined by the upper plate portion 51a and both side plate portions 51b and 51c. In addition, the upper plate portion 51a have insertion holes 51h for screws 54 used to mount the first vertical rail 51 to the chassis 14. Moreover, the longitudinal length of the first vertical rail 51 is approximately equal to the short-side length of the chassis 14.

As illustrated in FIG. 6, the first vertical rail 51 is mounted on the rear face-side (the side opposite to the cold cathode tube 17) of the bottom plate 14a of the chassis 14 at a position relatively consistent to one of the end parts of the support base portion 43 included in the stand 40 or, in other words, at a position opposing the first support portion 44. More specifically, the first vertical rail 51 is mounted to the chassis 14 in a state where the lower plate portions 51d and 51e oppose the side of the chassis 14 and a longitudinal direction of the first vertical rail 51 is oriented in the vertical direction (the Y-axis direction in FIG. 6). At this point, since the chassis 14 is set upright by the stand 40 such that the short-side outer edge part 21a is oriented in the vertical direction, the first vertical rail 51 is mounted such that the longitudinal direction thereof is approximately parallel to the short-side outer edge part 21a (the short side of the bottom plate 14a of the chassis 14). The longitudinal length of the first vertical rail 51 is set approximately equal to the short-side length of the chassis 14, and a state is created where both longitudinal end parts of the first vertical rail 51 are mounted across both short-side end parts of the chassis 14 or, in other words, mounted from the upper long-side outer edge part 21b to the lower long-side outer edge part 21b.

Meanwhile, the second vertical rail 52 is mounted on the rear face-side (the side opposite to the cold cathode tube 17) of the bottom plate 14a of the chassis 14 at a position relatively matching the other end part of the support base portion 43 included in the stand 40 or, in other words, at a position opposing the second support portion 45. In the same manner as the first vertical rail 51, the second vertical rail 52 is mounted to the chassis 14 with the longitudinal direction thereof oriented in the vertical direction (the Y-axis direction in FIG. 6) or, in other words, with the longitudinal direction of the second vertical rail 52 approximately parallel to the short-side outer edge part 21a (the short side of the bottom plate 14a of the chassis 14). The longitudinal length of the second vertical rail 52 is set approximately equal to the short-side length of the chassis 14, and a state is created where both longitudinal end parts of the second vertical rail 52 are mounted across both short-side end parts of the chassis 14 or, in other words, mounted from the upper long-side outer edge part 21b to the lower long-side outer edge part 21b.

As described above, the first vertical rail 51 is mounted to a position opposing the first support portion 44 of the stand 40 and the second vertical rail 52 is mounted to a position opposing the second support portion 45 of the stand 40. In other words, the first vertical rail 51 and the second vertical rail 52 are arranged away from each other by a distance equal to the distance between the first support portion 44 and the second support portion 45 (in the present embodiment, the longitudinal length of the support base portion 43) and mounted to the chassis 14. In addition, since both the first vertical rail 51 and the second vertical rail 52 have their longitudinal directions oriented in the vertical direction or, in other words, approximately parallel to the short-side direction of the chassis 14, the first vertical rail 51 and the second vertical rail 52 are juxtaposed parallel to and separated from each other by a middle area 53 equal to the distance described above on the rear face-side of the chassis 14.

Furthermore, the first diagonal rail (diagonal rail) 61 and the second diagonal rail (diagonal rail) 62 are mounted in the middle area 53 between the first vertical rail 51 and the second vertical rail 52 described above. The first diagonal rail 61 and the second diagonal rail 62 have a hollow structure formed by subjecting metal plates to a bending process and are configured so as to have approximately the same structure as the first vertical rail 51 described above (see FIG. 8). As illustrated in FIG. 6, the first diagonal rail 61 and the second diagonal rail 62 are connected to the first vertical rail 51 and the second vertical rail 52 such that the first diagonal rail 61 and the second diagonal rail 62 intersect each other with the longitudinal directions thereof aligned with directions that intersect the vertical direction (in other words, the vertical direction of the chassis 14). In the present embodiment, the first diagonal rail 61 and the second diagonal rail 62 intersect each other with the first diagonal rail 61 inserted into a cutout formed on the second diagonal rail 62.

One of the end parts of the first diagonal rail 61 is connected to a lower end part of the first vertical rail 51 and the other end part of the first diagonal rail 61 is connected to an upper end part (a portion on the upper side of a central part) of the second vertical rail 52. Meanwhile, one of the end parts of the second diagonal rail 62 is connected to a lower end part of the second vertical rail 52 and the other end part of the second diagonal rail 62 is connected to an upper end part (a portion on the upper side of a central part) of the second vertical rail 52. As described above, the first diagonal rail 61 and the second diagonal rail 62 are installed between the first vertical rail 51 and the second vertical rail 52 so as to intersect each other or, in other words, so as to form cross-braces. In other words, a configuration is adopted where the first diagonal rail 61 and the second column member 62 are coupled to each other at respective central parts in the longitudinal directions and the first vertical rail 51 and the second vertical rail 52 are coupled via the first diagonal rail 61 and the second column member 62.

Hereinafter, a connection between the first vertical rail 51, and the first diagonal rail 61 and the second diagonal rail 62, will be described in detail.

The upper end part of the second diagonal rail 62 is connected to the upper end part of the first vertical rail 51. As illustrated in FIG. 9, the upper end part of the first vertical rail 51 has a cutout 51f on the side closer to the second vertical rail 52 (i.e., parts of the side plate portion 51b and the lower plate portion 51 are cut out). A width of the cutout 51f along the longitudinal direction of the first vertical rail 51 is wider than a width of the second diagonal rail 62 and the second diagonal rail 62 is inserted at an angle. An end of the second diagonal rail 62 is inserted through the cutout 51f into the inside (hollow part) of the first vertical rail 51 in a direction that intersects the vertical direction or, in other words, at an angle with respect to the first vertical rail 51. Namely, It is inserted from the lower side at an angle. In other words, the end of the second diagonal rail 62 is to be superimposed on the upper plate portion 51a of the first vertical rail 51, and the first vertical rail 51 and the second diagonal rail 62 are collectedly mounted to the rear surface of the chassis 14, that is, mounted to the chassis together, by the screws 54 inserted through the insertion hole 51h.

Meanwhile, the lower end part of the first diagonal rail 61 is connected to the lower end part of the first vertical rail 51. As illustrated in FIG. 10, among the lower end part of the first vertical rail 51, a cutout 51g for inserting the first diagonal rail 61 is formed on a side of the second vertical rail 52 (the side plate portion 51b and the lower plate portion 51d). A width of the cutout 51g along the longitudinal direction of the first vertical rail 51 is set wider than a width of the first diagonal rail 61 so as to enable the first diagonal rail 61 to be inserted in an inclined direction. An end of the first diagonal rail 61 is inserted through the cutout 51g into the inside (hollow part) of the first vertical rail 51 in a direction intersecting the vertical direction or, in other words, in an inclined direction with respect to the first vertical rail 51. Namely, it is inserted from the upper side at an angle. In other words, the end of the first diagonal rail 61 is to be superimposed on the upper plate portion 51a of the first vertical rail 51 (see FIG. 11). The first vertical rail 51 and the first diagonal rail 61 are collectedly mounted or tightened together to the rear face-side of the chassis 14 together with a cover member 71 to be described later.

The lower end part of the first vertical rail 51 described above is further configured so as to oppose (abut) an upper end part of the first support portion 44 of the stand 40 at a lower end edge of the chassis 14. The cover member 71 made of resin is mounted so as to cover the lower end part of the first vertical rail 51, the lower end part of the first diagonal rail 61, and the first support portion 44. As illustrated in FIG. 10, the cover member 71 is arranged such that an upper end part thereof is approximately consistent with an upper end of an intersection of the first vertical rail 51 and the first diagonal rail 61 and a lower end part of the cover member 71 is approximately consistent with an upper end of an intersection of the first support portion 44 and the support base portion 43 (an upper face of the support base portion 43).

The cover member 71 is configured so as to cover the upper plate portion 51a and the side plate portions 51b and 51c of the first vertical rail 51 and almost the entire first support portion 44 (including the rear face-side thereof). As illustrated in FIG. 11, the cover member 71 has a projecting part 72 protruding to the inside of the cover member 71 at a portion overlapping the end of the first support portion 44. An under end part (a side opposing the first support portion 44) of the projecting part 72 includes a depression 72a depressed in a shape conforming to the end of the first support portion 44. When the end of the first support portion 44 is fit into the depression 72a, the first support portion 44 is roughly fixed to the cover member 71. Such a fitting structure enables the connection strength between the first support portion 44 and the cover member 71 to be improved. Meanwhile, an upper end part (a side opposing the first vertical rail 51) of the cover member 71 has a flat face 72b, whereby the first vertical rail 51 is to be placed on the flat face 72b. In addition, the projecting part 72 includes a through hole 72c that penetrates the projecting part 72 from a lower end part 72a to an upper end part 72b thereof, whereby the first support portion 44 and the first vertical rail 51 are to oppose (abut) each other via the through hole 72c.

The cover member 71 and the first support portion 44 are connected to each other by the screws 47 inserted from a front side (leftward in FIG. 11) of the cover member 71. Meanwhile, the first vertical rail 51 and the first diagonal rail 61 described above are tightened together and mounted to the rear face-side of the chassis 14 together with the cover member 71 by the screws 54 inserted from a front side (leftward in FIG. 11) of the cover member 71. In this manner, the first vertical rail 51 and the first support portion 44, and the first diagonal rail 61 and the first support portion 44, are respectively connected (coupled) via the cover member 71.

On the other hand, an upper end part of the first diagonal rail 61 is connected to an upper end part of the second vertical rail 52 by the same configuration as the connection between the first vertical rail 51 and the second diagonal rail 62 described above. In other words, the upper end part of the second vertical rail 52 and the upper end part of the first diagonal rail 61 are tightened together and mounted to the rear face-side of the chassis 14 by the screws 54.

In addition, a lower end part of the second diagonal rail 62 is connected to a lower end part of the second vertical rail 52 by the same configuration as the connection between the first vertical rail 51 and the first diagonal rail 61 described above. In other words, the lower end part of the second vertical rail 52 and the lower end part of the second diagonal rail 62 are tightened together and mounted to the rear face-side of the chassis 14 together with the cover member 71 by the screws 54.

Furthermore, the lower end part of the second vertical rail 52 is further configured so as to oppose (abut) an upper end part of the second support portion 45 of the stand 40 at the lower end edge of the chassis 14. The cover member 71 made of resin is mounted so as to cover the lower end part of the second vertical rail 52, the lower end part of the second diagonal rail 62, and the second support portion 45. The cover member 71 and the second support portion 45 are connected to each other by the screws 47 in the same configuration as the connection between the cover member 71 and the first support portion 44 described above. On the other hand, the second vertical rail 52 and the second diagonal rail 62 are tightened together and mounted to the rear face-side of the chassis 14 together with the cover member 71 in the same configuration as the first vertical rail 51 and the first diagonal rail 61 described above. In this manner, the second vertical rail 52 and the second support portion 45, and the second diagonal rail 62 and the second support portion 45, are respectively connected (coupled) via the cover member 71.

As described above, according to the present embodiment, the backlight unit 12 includes the stand 40 that supports the chassis 14 in a state where the plate-like face of the bottom plate 14a of the chassis 14 is oriented in a vertical direction, wherein the first support portion 44 and the second support portion 45 provided on the stand 40 are to directly support a lower end part of the chassis 14. In addition, provided on the rear face-side (the face on the opposite side to the cold cathode tube 17) of the chassis 14 are the first vertical rail 51 and the second vertical rail 52 which are respectively connected to the first support portion 44 and the second support portion 45 and which have their longitudinal directions oriented in the vertical direction, and the first diagonal rail 61 and the second diagonal rail 62 which are respectively connected to the first support portion 44 and the second support portion 45 and which have their longitudinal directions oriented in directions intersecting the vertical direction.

According to such a configuration, since the chassis 14 is reinforced by the vertical rails 51 and 52 and the diagonal rails 61 and 62, and the vertical rails 51 and 52 and the diagonal rails 61 and 62 are connected to the support portions 44 and 45, distortion force that is likely to concentrate on the connections between the chassis 14 and the support portions 44 and 45 can be dispersed. As a result, distortion of the chassis 14 can be suppressed.

As is the case with the present embodiment, with the chassis 14 supported by the stand 40 in an upright state oriented in the vertical direction, distortion force tends to concentrate on the connection between the chassis 14 and the stand 40 due to the own weight, vibration, and the like of the chassis 14 (backlight unit 12). Should distortion occur on the chassis 14, a variance may occur among distances between the plurality of aligned cold cathode tubes 17 and the chassis 14, creating a difference in output light intensity among the cold cathode tubes 17 and a risk of luminance unevenness of the backlight unit 12. In particular, in order to realize a thinner backlight unit 12 as is the case with the present embodiment, it is desirable to minimize the distance between the cold cathode tube 17 and the chassis 14. In this case, a slight change in the distance between the cold cathode tube 17 and the chassis 14 relatively causes a significant variance in output light intensity.

In consideration thereof, the present embodiment is configured such that the vertical rails 51 and 52 and the diagonal rails 61 and 62 are provided together on the rear face of the chassis 14 or, in other words, on the surface of the bottom plate 14a on the opposite side from the cold cathode tube 17 (the surface opposite from the output side of illumination light).

Since the vertical rails 51 and 52 are mounted on the chassis 14 with their longitudinal directions oriented in the vertical direction, the chassis 14 is reinforced with respect to the vertical direction and distortion due to the own weight of the backlight unit 12 can be suppressed. In addition, since the first vertical rail 51 is connected to the first support portion 44 and the second vertical rail 52 is connected to the second support portion 45, distortion force that is likely to concentrate on the connections between the chassis 14 and the support portions 44 and 45 can be dispersed in the vertical direction through the vertical rails 51 and 52. As a result, distortion of the chassis 14 can be suppressed by preventing the concentration of localized distortion force.

Furthermore, the diagonal rails 61 and 62 provided together with the vertical rails 51 and 52 are connected to the support portions 44 and 45 and mounted onto the chassis 14 such that the longitudinal directions of the diagonal rails 61 and 62 are oriented in directions intersecting the vertical direction. As a result, the chassis 14 is also reinforced in the alignment directions of the first diagonal rail 61 and the second diagonal rail 62, and distortion force that tends to concentrate on the connections between the chassis 14 and the support portions 44 and 45 can be dispersed not only in the vertical direction but also in directions intersecting the vertical direction. Accordingly, since distortion force is to be dispersed over a wide range of the chassis 14, distortion of the chassis 14 can be reliably suppressed. As a result, since the distance between the cold cathode tube 17 and the chassis 14 can be kept constant, an even illumination luminance distribution free of luminance unevenness can be realized with the backlight unit 12.

Moreover, in the present embodiment, the first diagonal rail 61 and the second diagonal rail 62 are arranged so as to intersect each other in the middle area 53 between the separately arranged first vertical rail 51 and second vertical rail 52. The lower end part of the first diagonal rail 61 is connected to the first vertical rail 51 and the upper end part of the first diagonal rail 61 is connected to the second vertical rail 52. Meanwhile, the upper end part of the second diagonal rail 62 is connected to the first vertical rail 51 and the lower end part of the second diagonal rail 62 is connected to the second vertical rail 52.

Due to such a configuration, since the vertical rails 51 and 52 arranged separated from each other are connected to the diagonal rails 61 and 62 arranged so as to intersect each other or, in other words, arranged as cross-braces between the vertical rails 51 and 52 (in the middle area 53), distortion force generated at the connections between the chassis 14 and the support portions 44 and 45 can be dispersed among the vertical rails 51 and 52 as well as the diagonal rails 61 and 62. In addition, vibration generated on the chassis 14 that is one of the sources of the distortion force can be synchronized among the vertical rails 51 and 52 arranged separate from each other so as to reduce the distortion force. As described above, by reducing and dispersing distortion force, distortion of the chassis 14 can be reliably suppressed and an even illumination luminance distribution free of luminance unevenness can be realized.

Furthermore, in the present embodiment, the first vertical rail 51 and both diagonal rails 61 and 62, as well as the second vertical rail 52 and both diagonal rails 61 and 62, are collectively mounted or tightened together to the chassis 14 by the screws 54.

In this case, since the vertical rails 51 and 52 and the diagonal rails 61 and 62 can be mounted to the chassis 14 at the same time, the work required for a mounting operation of the members can be reduced as compared to a case where the members are mounted individually. In addition, since a secure connection can be realized by tightening the vertical rails 51 and 52 and the diagonal rails 61 and 62 together, distortion force generated on the chassis 14 can be reliably dispersed among the vertical rails 51 and 52 and the diagonal rails 61 and 62.

Moreover, in the present embodiment, the first vertical rail 51 and the second vertical rail 52, as well as the first diagonal rail 61 and the second diagonal rail 62, are configured as metallic members.

In order to reinforce the chassis 14 using the vertical rails 51 and 52 and the diagonal rails 61 and 62, the members desirably have high bending strength. As such, the members are preferably made of a metallic material with relatively high bending strength such as iron.

Moreover, in the present embodiment, the first vertical rail 51 and the second vertical rail 52, as well as the first diagonal rail 61 and the second diagonal rail 62, have a hollow structure.

In this manner, by configuring the vertical rails 51 and 52 and the diagonal rails 61 and 62 to be mounted on the chassis 14 in a hollow structure, the weight of the members can be reduced. Accordingly, an increase in weight by mounting the vertical rails 51 and 52 and the diagonal rails 61 and 62 on the chassis 14 can be minimized.

While a preferred embodiment of the present invention has been disclosed, the present invention is not limited to the embodiment disclosed by the above description and accompanying drawings and, for example, the embodiments described below also fall within the technical scope of the present invention.

(1) In the embodiment described above, a backlight unit 12 is exemplified in which the chassis 14 is supported by the stand 40 in an upright state where the plate-like face of the bottom plate 14a of the chassis 14 is oriented in a vertical direction. However, the configuration of the present invention is intended to yield results as long as the chassis 14 is set upright. Therefore, for example, a configuration in which the chassis 14 is supported upright in a state where the plate-like face of the bottom plate 14a is deviated from the vertical direction or, a configuration in which the chassis 14 is supported upright in an inclined state is also to be included in the present invention.

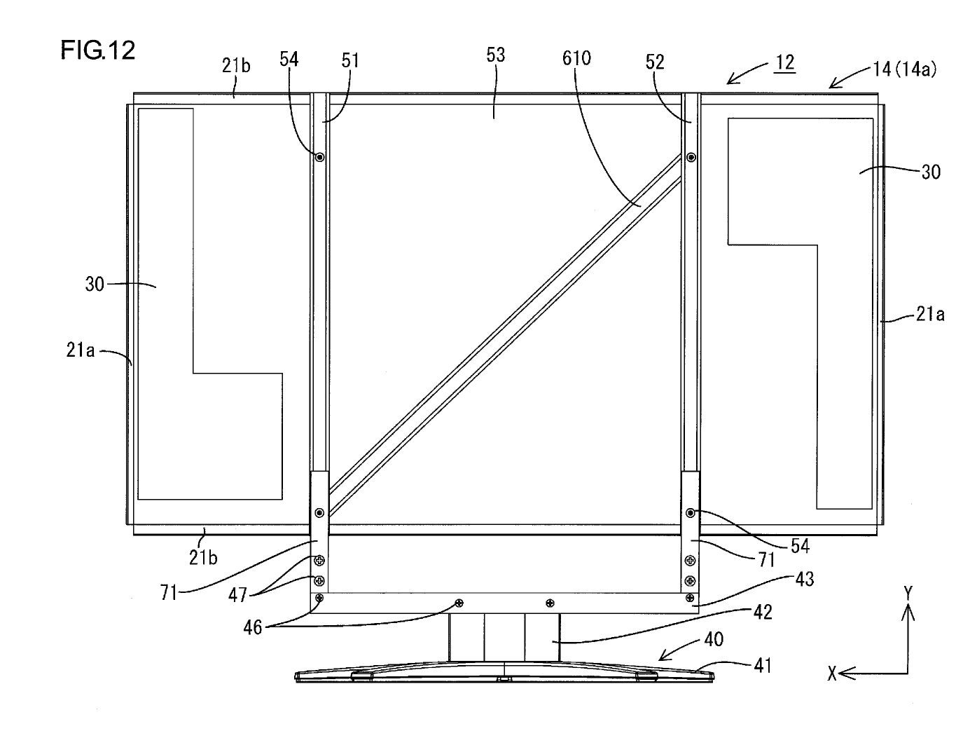

(2) In the embodiment described above, while a configuration is adopted in which the first diagonal rail 61 and the second diagonal rail 62 intersect each other, for example, a configuration such as that illustrated in FIG. 12 can be adopted instead. That is, a configuration may be adopted in which a single diagonal rail 610 is installed between the first vertical rail 51 and the second vertical rail 52 arranged separated from each other with a longitudinal direction of the single diagonal rail 610 oriented in a direction intersecting the vertical direction. As shown, the numbers of installed vertical rails and diagonal rails, installation positions thereof, and the like are to be varyingly modified in consideration of relative magnitudes of the strength of the chassis and a generated distortion force. Accordingly, a configuration in which the numbers of installed vertical rails and diagonal rails, installation positions thereof, and the like are modified is to be also included in the present invention.

(3) In the embodiment described above, the vertical rails 51 and 52 and the diagonal rails 61 and 62 are configured so as to be made of iron plates with a higher bending strength than the aluminum chassis 14. However, the materials making up the members are arbitrary and, for example, the same material as the vertical rails and the diagonal rails may be used for the chassis. Nevertheless, in order to reduce the weight of the backlight unit 12, the chassis is desirably made of aluminum that is relatively light-weight and the vertical rails and the diagonal rails made of an iron-like member whose bending strength is higher than that of the chassis.

(4) In the embodiment described above, the vertical rails 51 and 52 and the diagonal rails 61 and 62 are configured so as to be connected to each other via the cover member 71. However, a configuration may also be adopted where the vertical rails 51 and 52 and the diagonal rails 61 and 62 are connected directly to each other instead of via the cover member.

(5) While a case where the cold cathode tube 17 is used as a light source has been described in the embodiment above, cases using other light sources such as a hot cathode tube are to be also included in the present invention.

1. An illumination device comprising:
a light source;
a chassis housing the light source;
a stand holding the chassis in an upright position with a support portion directly supporting the chassis;
a vertical rail mounted on a surface of the chassis away from the light source such that a longitudinal direction thereof is aligned with a vertical direction of the chassis and connected to the support portions; and
a diagonal rail mounted on the surface of the chassis such that a longitudinal direction thereof is aligned with a direction crossing the vertical direction of the chassis and connected to the support portion to which the vertical rail is connected.

2. The illumination device according to claim 1, wherein:
the stand holds the chassis such that a planar surface of the chassis is oriented along the vertical direction; and
the vertical rail is mounted on the chassis with the longitudinal direction thereof aligned with the vertical direction and the diagonal rail is mounted on the chassis with the longitudinal direction thereof aligned with the direction that intersects the vertical direction.

3. The illumination device according to claim 1, wherein:
the vertical rail includes a first vertical rail and a second vertical rail arranged away from each other;
the diagonal rail includes a first diagonal rail and a second diagonal rail that intersect each other;
a first end part of the first diagonal rail is connected to the first vertical rail and a second end part of the first diagonal rail is connected to the second vertical rail; and
a first end part of the second diagonal rail is connected to the first vertical rail and a second end part of the second diagonal rail is connected to the second vertical rail.

4. The illumination device according to claim 3, wherein the vertical rail and the diagonal rail are screwed to the chassis together.

5. The illumination device according to claim 1, wherein the vertical rail and the diagonal rail are made of metal.

6. The illumination device according to claim 1, wherein the vertical rail and the diagonal rail have a hollow structure.

7. A display device comprising:
the illumination device according to claim 1; and
a display panel that provides display using light from the illumination device.

8. The display device according to claim 7, wherein the display panel is a liquid crystal panel using liquid crystals.

9. A television receiver apparatus comprising the display device according to claim 7.
